(19) United States
(12) Patent Application Publication
(10) Pub. No.: US 2010/0332259 A1
(43) Pub. Date: Dec. 30, 2010

(54) Wellness Evaluation System And Method

(75) Inventor: Matthew James Condon, Fairway, KS (US)

Correspondence Address: LATHROP & GAGE LLP, 4845 PEARL EAST CIRCLE, SUITE 201, BOULDER, CO, 80301, US

(73) Assignee: ARC Technologies, LLC

(21) Appl. No.: 12/826,301

(22) Filed: Jun. 29, 2010

Related U.S. Application Data
(60) Provisional application No. 61/221,407, filed on Jun. 29, 2009.

(51) Int. Cl. G06Q 50/00

(52) U.S. Cl. 705/3

(57) ABSTRACT

A system and method for a wellness evaluation health plan participant. Initially, inputs are received which include (1) health risk assessment data indicating the participant's blood sugar, blood pressure, cholesterol, body mass index, alcohol and tobacco use; (2) an injury report including previous personal injury and pain information for the participant; and (3) an ergonomic analysis of the participant's jobsite. In response to these inputs, wellness exercise recommendations are generated including a set of pre-existing injury prevention exercises based on the injury report, and exercises based on potential worksite injury as determined by the ergonomic jobsite analysis. The participant may be sent a list of reading material including at least one article based on the health risk assessment.

### RELATED APPLICATIONS

This application claims benefit and priority to U.S. Patent Application Ser. No. 61/221,407, filed Jun. 29, 2009, the disclosure of which is incorporated herein by reference.

### BACKGROUND

As the U.S. Healthcare Industry evolves and begins to comprehend the cost of lagging attention to preventative care initiatives, ‘wellness initiatives’ have emerged as an important part of the industry's future. To date, the healthcare industry has failed to implement a process that fully engages the needs of employers. It is thus desirable to have a process for capturing data that will beneficially impact both traditional group healthcare cost drivers and workers' compensation cost drivers. Moreover, there is a need for a simple and effective way of providing individualized exercise programs that will mitigate these cost drivers.

### BRIEF DESCRIPTION OF THE DRAWINGS

FIG. 1 is a system diagram showing an exemplary computer system for processing a set of inputs to generate corresponding outputs in one embodiment of the present system;

FIG. 2 is a flowchart showing an exemplary set of steps performed in response to health risk assessment and biological information;

FIG. 3 is a flowchart showing an exemplary set of steps performed in response to personal work comp history and other orthopedic injuries/pain reports; and

FIG. 4 is a flowchart showing an exemplary set of steps performed in response to potential target areas as determined by jobsite analysis.

### DETAILED DESCRIPTION

The present system and method is an internet-based wellness system that helps businesses' employees become more healthy and physically fit. The system receives inputs including group health carrier wellness criteria, group health aggregate data, government wellness subsidy criteria, members' health screening assessment data, worksite assessment data, and employee-specific injury history including individual and aggregate workers' compensation data from previous claims, and optional self-reported health-related injuries. Aggregate data is data that is combined and analyzed, which is typically the data that health insurance companies consider when determining premium costs per individual and per group. The data is input into a computer-implemented formula that results in a personalized workout plan for each employee (hereinafter ‘participant’) specific to their job segment, health needs, co-morbidity factors, group health risks and group goals.

The present system and method assigns exercises to participants based on several types of the information indicated above, which are collectively unique in the field of health care. Each participant receives recommendations for one cardiovascular exercise plus other targeted exercises, and one or more suggested articles to be read.

In addition, participants optionally have the ability to challenge co-workers and/or other departments within their organization. Participants may earn points by indicating that they have completed certain exercises. Participants may also be able to access their recommended workouts on any Internet-enabled computer or download suggested workouts to a portable device. Participants may also be able to purchase workout equipment for ‘points’ accumulated during the process described below.

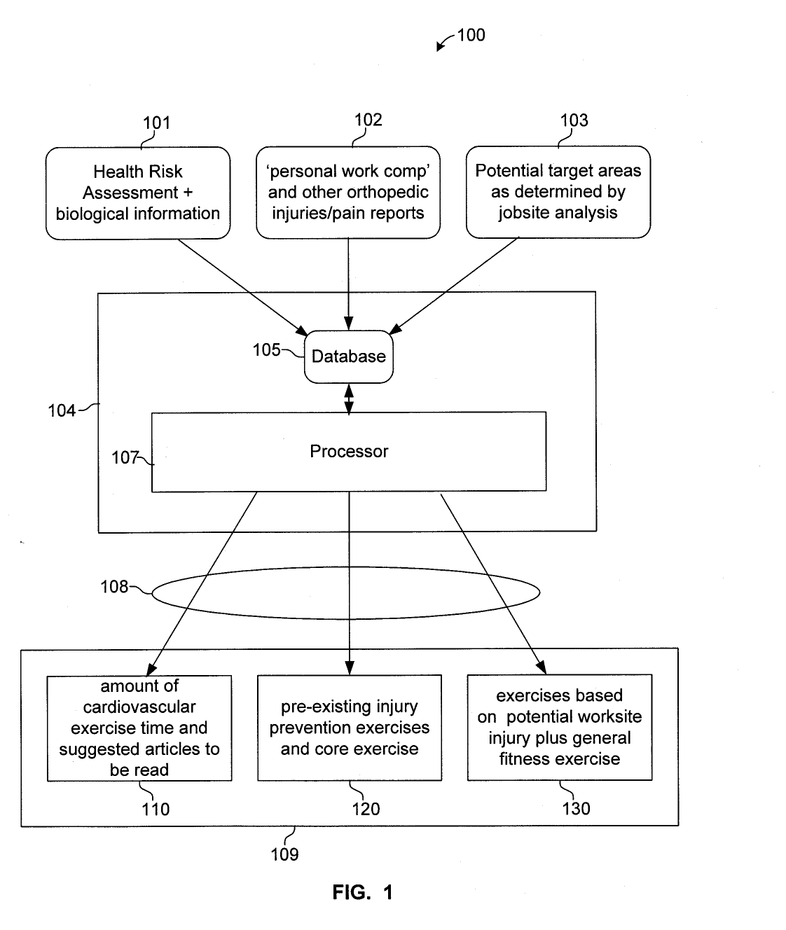

FIG. 1 is a system diagram showing an exemplary system 100 which processes a set of inputs to generate corresponding outputs in one embodiment of the present system and method. As shown in FIG. 1, system 100 comprises a computer system 104 including a processor 107 and a database 105.

In an exemplary embodiment, there are three categories of inputs 101, 102, 103, which are input to and stored in database 105 and processed by processor 107 to generate respective outputs 110, 120, 130 in response to risk factors for a particular participant:
(1) The results of Health Risk Assessment (HRA) plus biological information (including physical data) 101 on the participant determine the amount of cardiovascular exercise and health-related articles 110 a participant will receive (block 110). Articles and exercise recommendations are sent to participants via the Internet 108 for display on each participant's computer or mobile device 109.
(2) A report 102 including response to a ‘personal work comp history’ including workers' compensation reports for the participant (if any) and self-reported other orthopedic injuries/pain information determines a set of recommended pre-existing injury prevention exercises 120 for the participant. A ‘core’ exercise is also included by default in the recommended set of exercises (block 120). A core exercise is one which uses abdominal, low back, and/or other postural muscles.
(3) Target exercises 130 are generated by a jobsite analysis 103 which is performed by an ergonomic specialist. This jobsite analysis indicates what types of injuries the participant is likely to experience as a result of ergonomic realities of the participant's work environment. The jobsite analysis generates a minimum of one and a maximum of two potential target area inputs exercises based on potential worksite injury plus general fitness exercise (block 130).

In an exemplary embodiment, the exercise(s) recommended for each of the three categories 101, 102, 103 constitutes one-third of the total recommended workout.

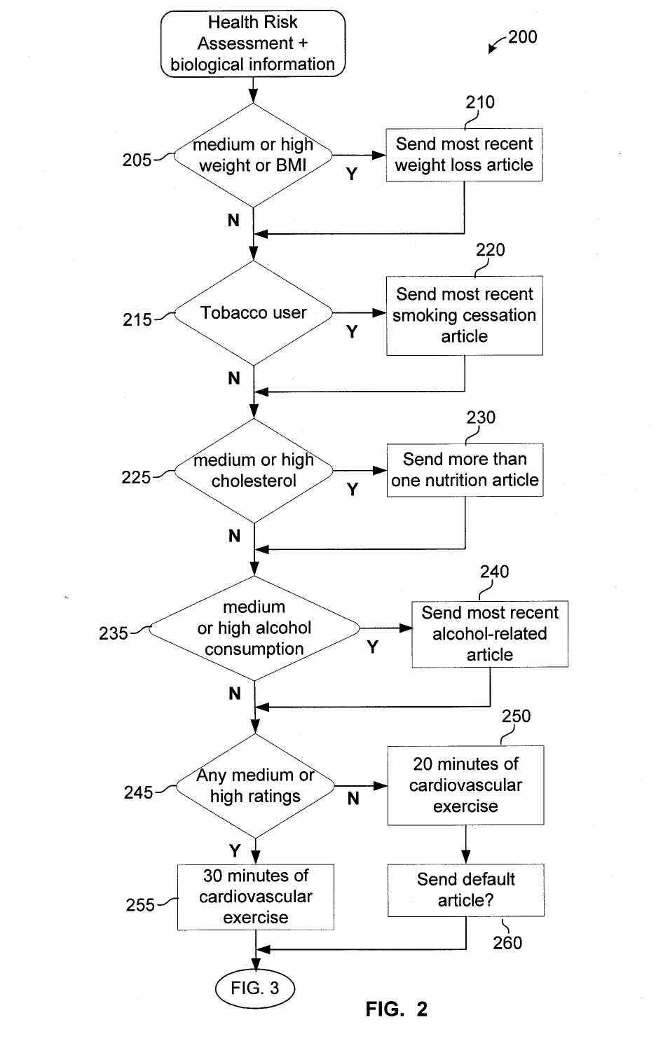

FIG. 2 is a flowchart showing an exemplary set of steps performed in response to health risk assessment and biological information. The results of Health Risk Assessment (HRA) plus biological information on a participant determine the amount of cardiovascular exercise and suggested health-related articles to be read by the participant.

Health Risk Assessments measure factors including some or all of weight, blood sugar, blood pressure, cholesterol, BMI (body mass index, an indicator of body mass relative to height), alcohol use and tobacco use. In an exemplary embodiment, each HRA provides a rating of low, medium or high for each of the above factors.

As shown in FIG. 2, at step 205, if a participant is flagged medium or high with respect to weight, or with medium or high BMI, they will receive a recent weight loss article on their personal system web page, at step 210. If a participant is flagged as a tobacco user (step 215), they will receive the most recent smoking cessation article (step 220), as tobacco use is deemed to put the user in at least a medium risk category. If a participant is flagged with medium or high cholesterol (step 225), they will receive more than one nutrition article (step 230). Optionally, if a participant is flagged for medium or high alcohol consumption (step 235) they will receive a recent alcohol-related article (step 240). Otherwise, a default health-related article is sent to the participant.

In an exemplary embodiment, every participant receives either 20 or 30 minutes of recommended cardiovascular exercise. If a participant receives a medium or high rating on any of the above factors (step 245), they will receive a recommendation for 30 minutes of cardiovascular exercise (step 250). Otherwise they receive a 20 minute exercise recommendation (step 255). ‘Featured’ articles will be made available on an individual home web page which is created for each participant.

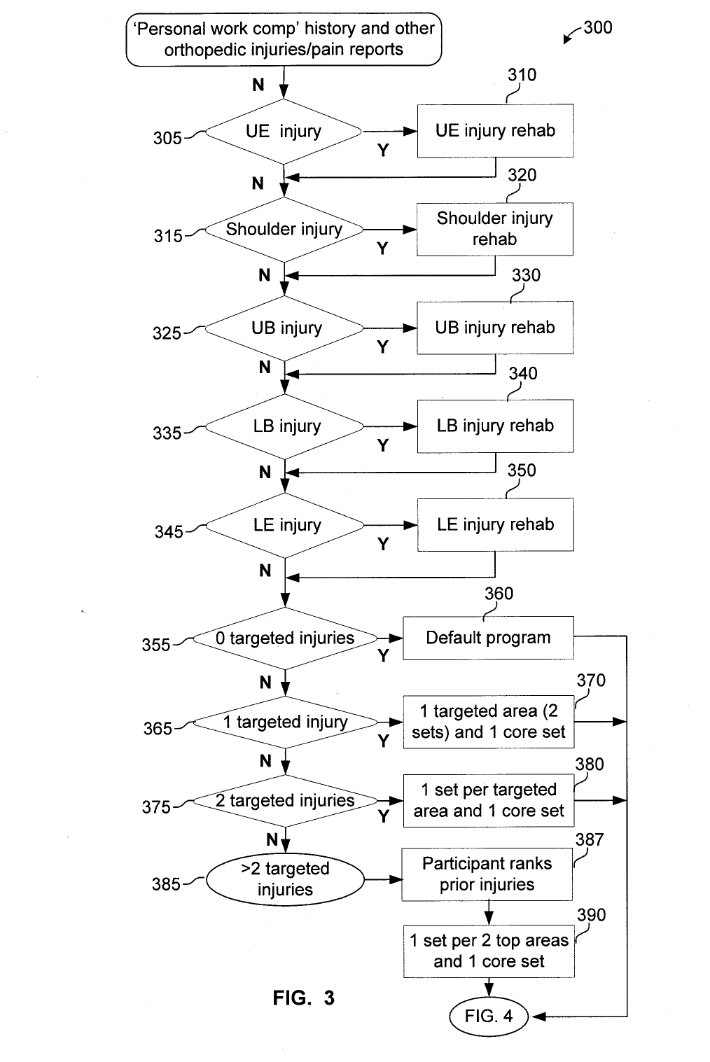

FIG. 3 is a flowchart showing an exemplary set of steps performed in response to personal work comp history and other orthopedic injuries and pain reports. Target area exercises are determined by the response to the participant's personal work comp history and pain indications. This information is generated either by HRA/employee self-report process (input (1), in FIG. 1) and/or responses provided by the employer describing prior work comp injuries they have had treated for the employee, and other self-reported orthopedic injuries/pain indications. Exercise recommendation are accordingly generated to protect the participant from exacerbating previous injuries that will impact the participant's workplace productivity.

As shown in FIG. 3, at step 305, if a participant reports an upper extremity (UE) injury then the participant is flagged for UE injury rehabilitation as a target area, at step 310. If the participant reports a shoulder injury (step 315), then the participant is flagged for shoulder injury rehabilitation as a target area (step 320). If the participant reports an upper back (UB) injury (step 325), then the participant is flagged for UB injury rehabilitation as a target area (step 330). If the participant reports a lower back injury (step 335), then the participant is flagged for lower back (LB) injury rehabilitation as a target area (step 340). If the participant reports a lower extremity (LE) injury (step 345), then the participant is flagged for LE injury rehabilitation as a target area (step 350).

Each participant receives three exercises of six to twenty repetitions based on the following logic. If the participant is not flagged for any targeted areas (step 355), then the participant receives a default program which includes two ‘general’ exercise sets, for example body weight squats and pushups, and one ‘core’ exercise set (step 360). If the participant is flagged for only one targeted area (step 365), then the participant's program includes two exercise sets for the one ‘targeted area’ (as indicated by the injury report) and one core (abdominal, low back, postural) exercise set (step 370).

If the participant is flagged for exactly two targeted areas (step 375), then the participant's program includes one exercise set for each of the two ‘targeted areas’ (as indicated by the injury report)—one exercise set for the first target area, and one exercise set for the second target area, as well as one ‘core’ exercise set (step 380).

If the participant is flagged with more than two targeted areas (step 385), then the participant is instructed to rank the prior injuries according to the participant's perception of the degree to which the injury currently impacts their functioning, so that the system can determine the two potentially most impactful areas, at step 387. The participant's program will then include one exercise set for each of the two top-ranked ‘targeted areas’ (as ranked by the participant)—one exercise set for the top-ranked target area, and one exercise set for the next-to-top-ranked target area, plus one ‘core’ exercise set (step 390).

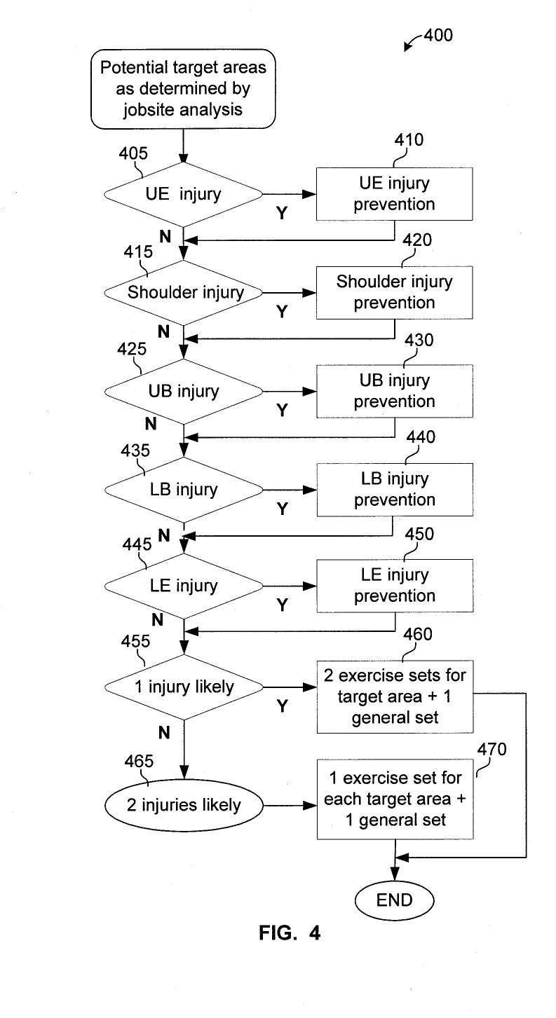

FIG. 4 is a flowchart showing an exemplary set of steps performed in response to potential target areas as determined by jobsite analysis. As shown in FIG. 4, target exercises are generated by a jobsite analysis performed by an ergonomic specialist. In an exemplary embodiment, the jobsite analysis provides a minimum of one and a maximum of two non-employee-specific potential target area inputs representing specific injuries likely to be incurred by employees as a result of the ergonomics of the workplace environment.

At step 405, if jobsite analysis determines that a participant's worksite activity leads to a likelihood of upper extremity (UE) injury, then the participant is flagged for upper extremity injury prevention target area program input, at step 410. If jobsite analysis determines that the participant's worksite leads to likelihood of shoulder injury (step 415), then the participant is flagged for a shoulder injury prevention target area program input (step 420).

If jobsite analysis determines that the participant's worksite activity leads to likelihood of upper back (UB) injury (step 425), then the participant is flagged for upper back injury prevention target area program input (step 430).

If jobsite analysis determines that participant's worksite activity leads to likelihood of lower back (LB) injury (step 435), then the participant is flagged for lower back injury prevention target area program input (step 440). If jobsite analysis determines that the participant's worksite activity leads to likelihood of lower extremity (LE) injury (step 445), then the participant is flagged for lower extremity injury prevention target area program input (step 450).

In an exemplary embodiment, jobsite analysis stipulates a minimum of one and a maximum of two potential injury areas for any given worksite. If jobsite analysis determines that the participant's worksite activity leads to a likelihood of one orthopedic injury (step 455), then the participants program includes two exercise sets for ‘targeted area’ (as directed by the jobsite analysis), and one ‘general’ exercise set, as defined by a ‘general’ pool of exercises, e.g., bodyweight squats (step 460).

If jobsite analysis determines that the participant's worksite activity leads to a likelihood of two different orthopedic injuries (step 465), then the participant's program includes two exercises sets, one for each ‘targeted area’ (as directed by the injury report)—one exercise set for the first targeted area, and one exercise set for the second targeted area, plus one ‘general’ exercise set, as defined by the ‘general’ pool of exercises (step 470).

Certain changes may be made in the above methods and systems without departing from the scope of that which is described herein. It is to be noted that all matter contained in the above description or shown in the accompanying drawings is to be interpreted as illustrative and not in a limiting sense. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall there between.

What is claimed is:

1. A computer-implemented method for wellness evaluation for a health plan participant comprising:
receiving inputs including:
health risk assessment including data indicating the participant's blood sugar, blood pressure, cholesterol, body mass index, alcohol and tobacco use;
an injury report including previous personal injury and pain information for the participant; and
an ergonomic analysis of the participant's jobsite;
generating, in response to said inputs, wellness exercise recommendations including:
a set of pre-existing injury prevention exercises based on the injury report; and
exercises based on potential worksite injury as determined by the ergonomic jobsite analysis.

2. The method of claim 1, including sending, to the participant, a list of reading material including at least one article based on the health risk assessment.

3. The method of claim 1, wherein in response to said inputs, the wellness exercise recommendations additionally include a recommended amount of cardiovascular exercise and specific core exercises.

4. The method of claim 1, wherein the article is made available on an individual Internet web page created for the participant.

5. A computer-implemented method for wellness evaluation for a health plan participant comprising:
receiving health information including health risk assessment and biological information for the participant;
determining, in response to the health information, a rating for the participant of low, medium, or high, with respect to risk factors including body mass index, tobacco use, cholesterol level, and alcohol consumption; and
generating wellness exercise recommendations, including an amount of cardiovascular exercise time for the participant, when the participant is determined to have at least a medium said rating for any one of the risk factors.

6. The method of claim 5, wherein:
when any said rating is at least medium, then recommending a first period of cardiovascular exercise for the participant, otherwise recommending a second period of cardiovascular exercise for the participant, where the second period is of shorter duration than the first period.

7. The method of claim 5, wherein, when the participant has at least a medium said rating for any of the risk factors, the participant is provided with a list of one or more corresponding health-related articles to be read.

8. The method of claim 7, wherein, when at least a medium rating is determined for the participant's body mass index, a weight loss article is included in the list.

9. The method of claim 7, wherein, when at least a medium rating is determined for the participant's cholesterol level, a nutrition article is included in the list.

10. The method of claim 7, wherein, when at least a medium rating is determined for the participant's alcohol consumption, an alcohol-related article is included in the list.

11. The method of claim 7, wherein, when it is determined that the participant is a tobacco user, a smoking cessation article is included in the list.

12. A computer-implemented method for wellness evaluation for a health plan participant comprising:
receiving an employee-specific injury history including worker's compensation information indicating previous personal injuries for the participant; and
generating, in response to the injury history, a list of recommended injury prevention exercises targeting respective ones of the previous personal injuries;
wherein, when the participant has multiple previous personal injuries, the exercises include at least one core exercise set and at least one exercise for each of two areas related to the targeted previous personal injuries.

13. The method of claim 12, wherein the injury history includes orthopedic injuries and pain information supplemental to the worker's compensation information.

14. The method of claim 12, wherein, when the participant has no previous personal injuries, the exercises include a default exercise program.

15. A computer-implemented method for wellness evaluation for a health plan participant comprising:
receiving an ergonomic analysis of the participant's jobsite; and
generating, in response to the analysis, a list of recommended injury prevention exercises targeting areas of the participant based on corresponding potential worksite injuries to the participant as determined from the jobsite analysis;
wherein, when the jobsite analysis indicates multiple potential worksite injuries, the exercises include at least one general exercise set and at least one exercise for each of two areas related to the potential worksite injuries.

16. A computer-implemented method for wellness evaluation for a health plan participant comprising:
receiving health information including:
workman's compensation history for the participant;
a health risk assessment measuring factors including weight, blood sugar, blood pressure, cholesterol, and body mass index; and
an ergonomic analysis of the participant's jobsite;
evaluating each of the factors to generate a rating of one of low, medium, and high, respectively, for each of the factors;
providing the participant with a recommended set of exercises in response to the workman's compensation history, the health risk assessment, and the jobsite analysis.

17. The method of claim 16, wherein the health risk assessment measures additional factors including alcohol use and tobacco use, and the participant is provided with a list of one or more corresponding health-related articles.

18. A computer-implemented method for wellness evaluation for a health plan participant comprising:
receiving inputs including:
an injury report including previous personal injury and pain information for the participant; and
an ergonomic analysis of the participant's jobsite; and
generating wellness exercise recommendations including:
pre-existing injury prevention exercises based on the injury report; and
exercises based on potential worksite injury as determined by the ergonomic analysis.

19. The method of claim 18, further including:
generating a health risk assessment for the participant from information indicating the participant's blood sugar, blood pressure, cholesterol, body mass index, alcohol and tobacco use; and
recommending an amount of cardiovascular exercise in response to the health risk assessment;
wherein (1) the recommended amount of cardiovascular exercise, (2) the recommended pre-existing injury prevention exercises, and (3) the exercises based on potential worksite injury each constitutes one-third of the total recommended exercise for the participant.

20. The method of claim 18, further including sending the participant a list of reading material including at least one article based on the health risk assessment.

21. The method of claim 18, wherein the article is made available on an individual Internet web page created for the participant.
